(19) United States
(12) Patent Application Publication
(10) Pub. No.: US 2023/0117779 A1
(43) Pub. Date: Apr. 20, 2023

(54) SECURE REPEATER FOR P25 LMR

(71) Applicant: TAIT INTERNATIONAL LIMITED, Christchurch (NZ)

(72) Inventor: Gordon Connell MARTIN, Christchurch (NZ)

(73) Assignee: TAIT INTERNATIONAL LIMITED, Christchurch (NZ)

(21) Appl. No.: 18/047,690

(22) Filed: Oct. 19, 2022

Related U.S. Application Data
(60) Provisional application No. 63/257,341, filed on Oct. 19, 2021.

(51) Int. Cl. H04W 76/45; H04L 69/08; H04W 12/037

(52) U.S. Cl. CPC H04W 76/45; H04L 69/08; H04W 12/037

(57) ABSTRACT

A process for extending unencrypted and encrypted voice for Land Mobile Radio communication across a wider geographical area using a repeater. The solution used is based upon an approach of embedding P25 Phase II signals inside P25 Phase I signals when required to communicate with a remote terminal.

This application claims priority of U.S. Provisional Application No. 63/257,341 filed Oct. 19, 2021, which is incorporated herein by reference, in its entirety.

### FIELD OF THE INVENTION

This invention relates to the operation of a vehicle mounted or fixed location repeater in a Land Mobile Radio (LMR) communication system. More particularly the invention relates to creating either, a) end to end encrypted voice across a repeater between the source network and one or more remote terminals, or b) end to end unencrypted voice across a repeater between the source network and one or more remote terminals.

### BACKGROUND TO THE INVENTION

Land Mobile Radio (LMR) systems traditionally support Push To Talk (PTT) operation supporting half duplex voice. LMR is a form of wireless communication technology based on standards that operate in narrow frequency bands; either 25 kHz, 12.5 kHz or 6.25kHz. Further, depending upon the standard, it may operate using Frequency Division Multiple Access (FMDA) or Time Division Multiple Access (TDMA) or both.

LMR is technology commonly optimized for voice. Examples of LMR technology include but are or not limited to P25 (APCO 25, Phase I and Phase II), Tetra, DMR (Digital Mobile Radio), or analogue LMR. LMR PTT voice either a) trunked in which it operates using an LMR server that forms a central controller to which all the LMR radios connect to for service or b) conventional in which it operates in a mode where a terminal transmission is received at a repeater and repeated or c) direct mode in which it operates in a mode where terminals communicate directly with other terminals with no intermediary.

Professional users such as police, fire and ambulance tend to use LMR technology because of its long range, secure operation, and relatively low cost per user. Trunked LMR systems typically operate via one or more communications towers which may commonly be located at a high site or building to maximize communication range in the geographic area. Trunked systems operate by assigning at least one channel as a control channel and a number of other channels for user traffic. A terminal will establish a call through negotiation over the control channel and subsequently be assigned to a traffic channel.

Conventional LMR systems also typically operate via one or more communications towers (sometimes referred to as repeaters) which may commonly be located at a high site or building to maximize communication range in the geographic area. Conventional LMR systems however do not have a control channel. In this mode a user will typically make a manual selection of a channel at a terminal that is known a posteriori. For both Trunked and Conventional LMR systems there exists an edge of range at some distance from the communications towers. Various methods exist in an attempt to extend range however one such method is to install a range extending repeater close to the edge of coverage. This repeater can be either a fixed location or mobile such as on a vehicle. This specification relates to range extending repeaters.

Apco P25 Phase I is a form or protocol of LMR that operates in 12.5 kHz channels and does this using Frequency Division Multiple Access (FMDA) which means a call is allocated to a particular channel (or frequency). Apco P25 Phase I uses a constant envelope modulation (C4FM) for both downlink and uplink. Apco P25 Phase I can support one call per channel (defined as a frequency) using a Full Rate IMBE vocoder that operates at a net bit rate of 4400 bps within the 9600 bps of the channel.

Apco P25 Phase II is a form or protocol of LMR that also operates in 12.5 kHz channels but it does this using both FDMA and Time Division Multiple Access (TDMA). This means a call is allocated to a particular time slot on a particular frequency where this combination is called a channel. Apco P25 Phase II uses a non-constant envelope modulation, HDQPSK for downlink and a constant envelope modulation HCPM for uplink. Apco P25 Phase II can support two calls on one frequency where each call operates in a channel of approximately 4800 pbs though uplink and down link data rates differ. Apco P25 Phase II uses a half rate AMBE vocoder that operates at a net bit rate of 2450 bps with the 4800 bps channel.

Range extending repeaters are commonly built using terminal radio units. Such an architecture means two terminals can be connected so that one acts as the receiver and the other as the transmitter. This is a typical method of building a relatively low-cost vehicle mounted repeater.

A problem exists relating to maintaining security and operation whilst extending range. Specifically,
when P25 Phase II voice is transmitted from a central site, it is transmitted in a TDMA mode, using a non-constant envelope modulation using a voice encoder, AMBE.
A mobile repeater based on a terminal is not capable of transmitting a non-constant envelope modulation. As a result, a repeater based on a terminal device cannot repeat the P25 phase II signal.

Prior solutions to the above problem are either
Decrypt and decode the P25 Phase II signal at the repeater and retransmit using unencrypted analog radio. This approach both loses security and loses the audio quality afforded by the digital vocoder. Products exist that operate in this way.
Decrypt and decode the P25 Phase II signal at the repeater and retransmit using P25 Phase I. This approach loses the end-to-end encryption and reduces audio quality because of a translation between the AMBE vocoder used in P25 Phase II and the P25 Phase I vocoder IMBE.

This specification describes solutions to the above problem in which the voice frames remain intact and preferably unchanged. The system described here selectively maintains both audio quality and security through the repeater all the way between the source network and the remote terminal.

### SUMMARY OF THE INVENTION

It is an object of the invention to provide a solution for extending coverage for P25 radio so that encryption remains end-to-end and the use of a high quality vocoder, AMBE is also end-to-end.

The invention resides in a method of repeating P25 Phase II codewords wherein the P25 Phase II codewords are extracted from a received P25 Phase II signal and retransmitted in a P25 Phase I signal. Similarly P25 Phase II codewords are extracted from a received P25 Phase I signal and retransmitted in a P25 Phase II signal.

Another aspect of the invention resides in a method of detecting that an incoming signal that is P25 Phase I contains P25 Phase II codewords and extracting these codewords and processing them as P25 Phase II. Similarly detecting that an incoming signal that is P25 Phase I contains a P25 Phase II codeword and encoding voice using the P25 Phase II encoding and transmitting that encoded sequence in response.

The system from which LMR is originating can be any type of LMR including but not limited to P25 (APCO 25 Phase I and II), Tetra, DMR (Digital Mobile Radio), or analogue LMR. The description of the LMR network described here is a P25 II and P25 Phase I. However the general approach of extracting encoded voice from one standard and embedding it in another standard is encompassed within the scope of this specification.

### BRIEF DESCRIPTION OF THE DRAWINGS

Preferred embodiments of the invention will be described with respect to the accompanying drawings, of which:

FIG. 1 shows a LMR system containing a vehicle mounted repeater,

FIG. 2a shows a method of extracting the downlink P25 Phase II Codeword and embedding it in P25 Phase I,

FIG. 2b shows the timing of extracting the downlink P25 Phase II Codeword and embedding it in P25 Phase I,

FIG. 3a shows a method of extracting the uplink P25 Phase II Codeword from a P25 Phase I signal,

FIG. 3b shows the timing of extracting the uplink P25 Phase II Codeword from a P25 Phase I signal,

FIG. 4 shows a signaling overview of downlink and uplink,

FIGS. 5a and 5b show flow diagrams for detecting at the terminal the presence of Apco Phase II and acting accordingly,

FIG. 6 shows a flow diagram for detecting repeater mode and processing packets accordingly,

FIG. 7a shows a sequence diagram for downlink end to end P25 Phase II voice operating across a repeater,

FIG. 7b shows a sequence diagram for uplink end to end P25 Phase II voice operating across a repeater,

FIG. 8 shows an implementation architecture for a repeater.

### DETAILED DESCRIPTION OF THE INVENTION

Referring to the drawings it will be appreciated the invention may be performed in a variety of ways, using many forms of LMR as a source of half duplex voice and many forms of VOIP technology.

Herein the text describes an implementation based on a vehicle mounted repeater. The same approach can apply to a fixed station repeater.

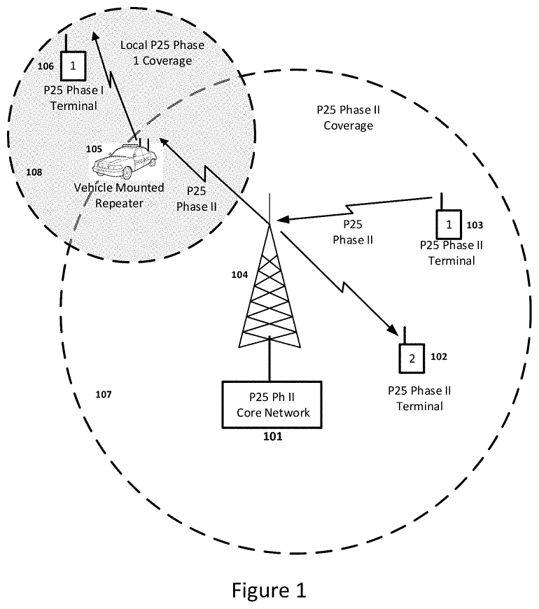

FIG. 1 shows a typical configuration of an LMR system operating via a repeater. A central controller 101 provides P25 Phase II LMR service to the area 107 via one or more base stations located at the tower 104. In the case of P25 phase II, the downlink communication uses a non-constant envelope modulation, the uplink uses a constant envelope modulation. A typical radius of a service area may be 30 km but this depends upon the exact setup of the network.

Portable terminals 103 and 102 acquire service directly from the tower 104. In FIG. 1 a Vehicle Mounted Repeater (VMR) 105 is also shown at the edge of coverage. The VMR 105 receives the P25 Phase II signal from the tower 104 and retransmits using P25 Phase I to supply service to a local area terminal 108 thus extending the coverage of the P25 Phase II network sourced at 104. Within a service area 108 one or more terminals can operate. In this case portable 106 is shown receiving service from the VMR 105.

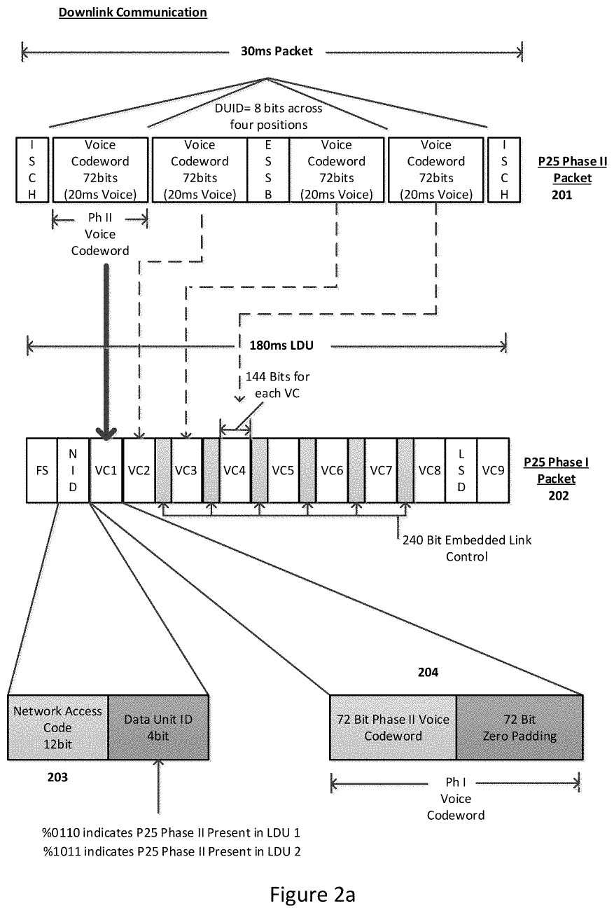

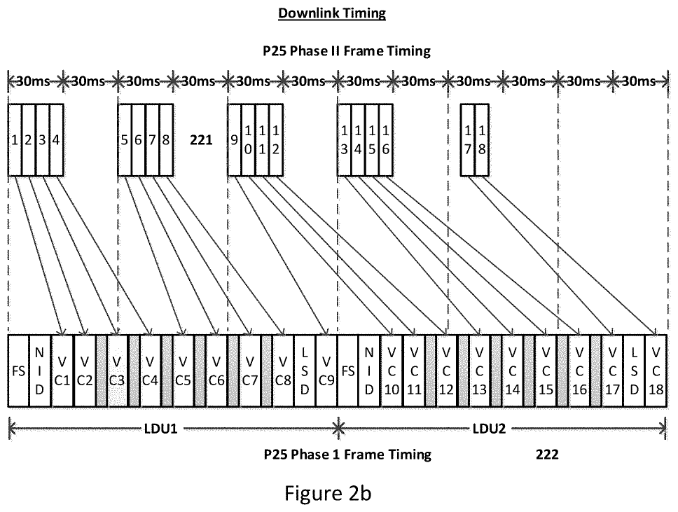

FIG. 2a shows the signaling structure of the present invention. In this case the diagram shows how the downlink case P25 Phase II signal 201 is processed and re-transmitted as a P25 Phase I signal 202.

The P25 Phase II signal 201, is made up of a number of parts within a 30 ms transmission burst. In the example shown, four voice code words are present. These code words are extracted in sequence without modification to their content and embedded in sequence into the Voice Codeword locations (VC1,2,3,4,5,6,7,9) within the P25 Phase I packet being prepared for retransmission at the VMR 105. The P25 Phase I packet shown in FIG. 2a is referred to as Link Data Unit (LDU) represents a 180 mS unit of time in the transmission. There are two Link Data Units LDU 1 and LDU 2. In this case LDU 1 is shown and it contains Voice Codewords VC 1 to VC9.

The P25 Phase II Voice codewords are made up of 72 bits and represent 20 ms of voice that is compressed. The P25 Phase I voice codewords are 144 bits. As shown in 204, the P25 Phase II 72 bit voice codeword has a further 72 bits appended made up of zero padding to form the codeword into 144 bits that can be fit directly into a P25 Phase I Voice codeword.

A further modification is made to the P25 Phase I signal before it is transmitted. It is necessary to identify that P25 Phase II signaling is embedded within the P25 Phase I signal so that the portable 106 can process it correctly. The P25 Phase I signal contains a Data Unit Identifier (DUID) that identifies the type of packet being sent. This is made up of a 4-bit message. An unused configuration is used to identify the presence of P25 Phase II. Specifically, %0110 and %1011 are selected to have this meaning. This is set in the DUID to identify that the packet contains P25 Phase II Voice codewords. %0110 means a P25 Phase II code word is contained within P25 Phase I LDU1. %1011 means P25 Phase II code word is contained within P25 Phase I LDU2. The P25 Phase II Voice Codewords may be encrypted or unencrypted.

FIG. 2b shows the timing of a downlink communication. The combination of an LDU1 and LDU2 represent a block of 360 ms (called a superframe) commonly used to communicate voice. 222 is a P25 Phase I superframe and consists of 18 voice codewords each containing 20 ms of speech. These are represented in FIG. 2b as VC1 to VC18 across LDU 1 and LDU2. These P25 phase 1 voice codewords are used to contain the P25 Phase II codewords on the downlink. A P25 Phase II channel consists of 30 ms bursts each separated by a 30 ms gap. A P25 phase II superframe also contains 18 voice codewords containing 20 ms of speech. However, these are spread across five 30 ms transmission bursts where four bursts contain 4 voice codewords and the fifth burst contains 2 voice codewords. 221 is a P25 Phase II superframe and consists of 18 voice codewords. These are represented in FIGS. 2b as 1 to 18 where they are spread across five 30 ms bursts. On the downlink, each P25 phase II voice codeword is received in order and placed into the P25 Phase I voice codeword as shown. FIG. 2b shows the synchronization between the P25 Phase II and P25 Phase I transmission timing where a P25 Phase II voice codeword is received and copied into the next available P25 Phase I voice codeword.

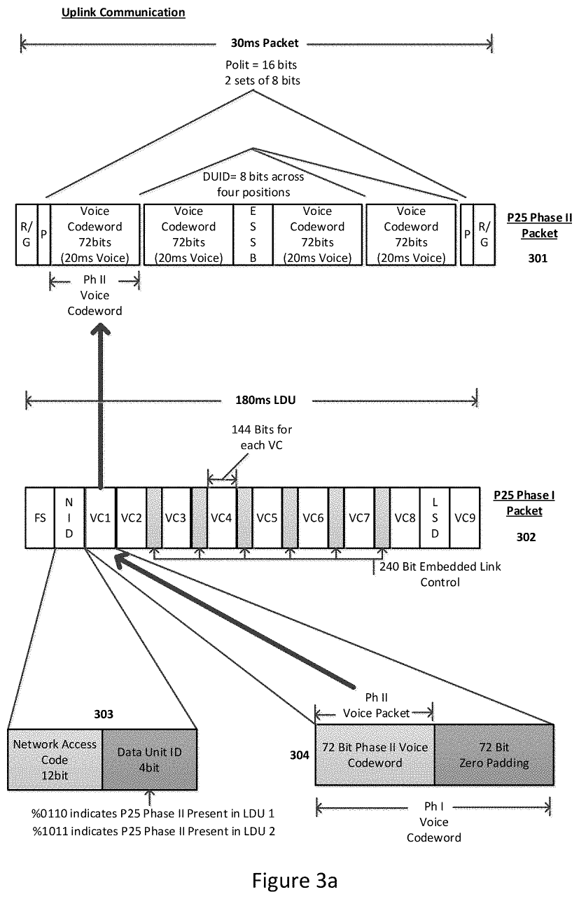

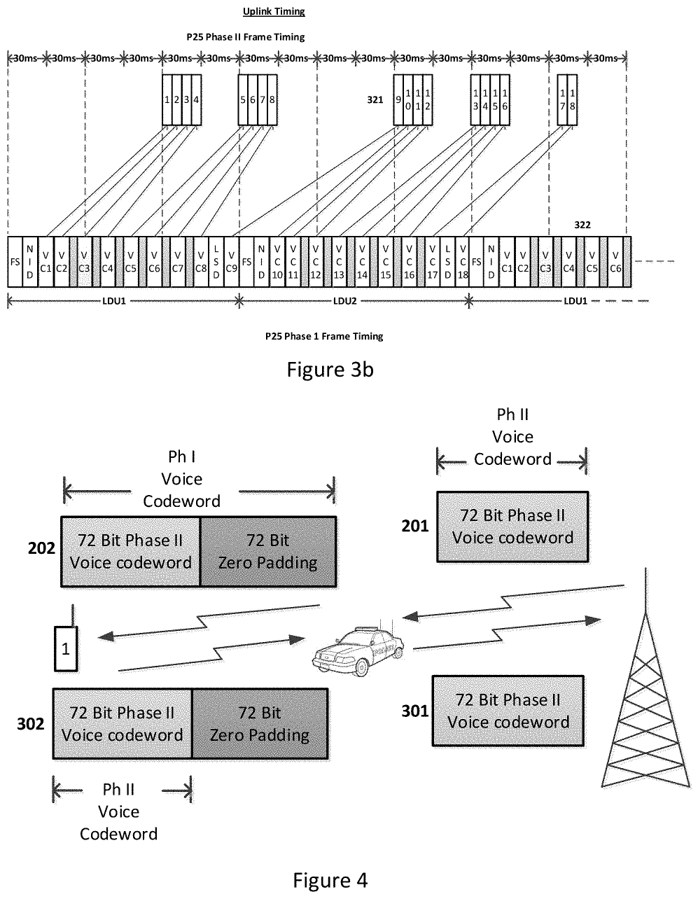

FIG. 3a shows the signaling structure of the present invention. In this case the diagram shows how the uplink where a P25 Phase I signal 302 is processed and re-transmitted as a P25 Phase II signal 301. The Phase I signal 302 is made up of several parts within a 180 ms transmission burst. In the example shown nine voice codewords are present (VC1,2,3,4,5,6,7,8,9). These are each 144 bits and each contain a P25 Phase II Voice Codeword as in the present invention. This structure is described in 304 in which the P25 Phase II codeword that is 72 bits has zero padding appended (a further 72 bits) to form a 144 bit codeword that will fit within the P25 Phase I codeword space. The P25 Phase 1 packet 302 also contains a NID identifying the type of packet. 303 shows how this DUID is set to %0110 or %1011 to indicate that P25 Phase II codewords are present in LDU 1 or LDU 2 respectively. When this packet is received at the VMR, 105 the VMR will now process it accordingly.

Upon receiving the packet 302, the VMR 105 will extract the P25 Phase II Voice Codeword, discard the zero padding and embed the P25 Phase II Voice Codeword into the P25 Phase II packet 301 ready for re-transmission. The P25 Phase II Voice Codewords may be encrypted or unencrypted.

FIG. 3b shows the timing of an uplink communication. Item 322 represents a P25 Phase I communication being received at the repeater. Item 321 represents a P25 Phase II transmission on the uplink. As each P25 Phase I voice codeword is received. The P25 Phase II voice codewords contained within it are extracted and copied into the next available uplink P25 Phase II voice codeword that will form a whole 30 ms burst.

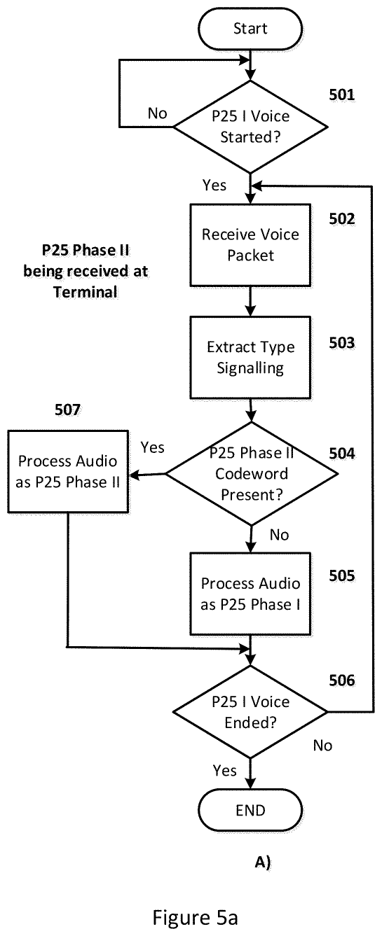

FIG. 4 shows further explanation of the signaling described in FIG. 2 and FIG. 3. The downlink P25 Phase II Voice Codeword 201 is extracted at the VMR 105 and embedded int a P25 Phase I Voice Codeword with zero padding to match the required codeword size. The uplink P25 Phase II Voice Codeword 302 is contained within the P25 Phase I Voice Codeword 302 and zero padding used to complete the codeword size. At the VMR 105, the P25 Phase II Voice Codeword is extracted and retransmitted as normal P25 Phase II 301

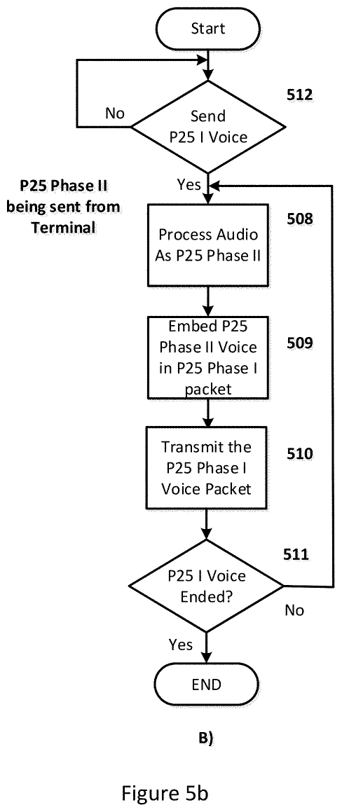

FIG. 5a shows a flow diagram detailing at the terminal 106 the process for receiving signaling of the form described in FIG. 4. Initially the terminal waits in step 501 for P25 Phase I Voice to start. At this stage the voice call starting may be normal P25 Phase I or P25 Phase I containing P25 Phase II. In step 502 the voice packet is received and in step 503 the DUID is extracted to establish what form of packet has arrived. In step 504, a check is made as to whether P25 Phase II is present.

If Phase II Voice Codewords are present, then in step 507 the phase II Voice codewords are extracted from the P25 Phase I codewords and are processed as normal P25 II Voice Codewords using the AMBE Half Rate vocoder and P25 Phase II decryption.

If Phase II Voice Codewords are not present, then in step 505 the phase I Voice codewords are processed as normal P25 Phase I Voice Codewords through using the IMBE Full Rate vocoder and P25 Phase I decryption.

Once the P25 Phase I voice call has ended then the process ends. If, however the voice continues, step 506 then the process returns to step 501 to continue the process.

FIG. 5b shows a flow diagram detailing the uplink process at the terminal 106. In step 512 a check is made to see if P25 Phase I signaling is to be transmitted containing P25 Phase II Voice packets. If this is the case, then in step 508 the audio from the microphone is processed as P25 Phase II using the AMBE Half Rate vocoder and formed in 72 bit messages. In step 509 the P25 Phase II codewords as embedded into the P25 Phase I signals as described in FIG. 3a including setting the DUID to indicate the presence of P25 Phase II. The P25 Phase I packets are formed and transmitted in step 510. In step 511 a check is made to see if the voice call has ended. If it has then the process stops. If it continues then the process returns to step 508.

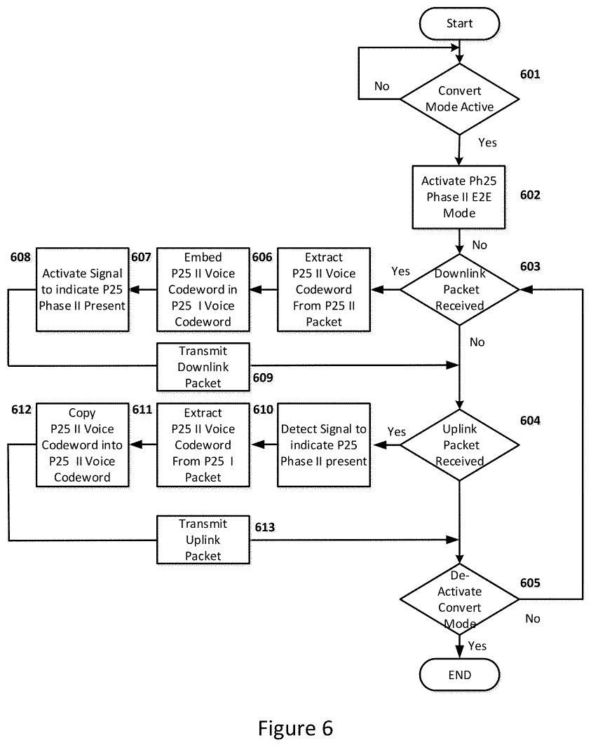

FIG. 6 describes a process at the VMR 105 for processing in coming signals whether they are downlink from the network 104 or uplink from the terminal 106. In step 601 a check is made to establish if the repeater is operating in a mode where P25 Phase II signalling is being converted into P25 Phase I in that P25 Phase II Voice Codewords are to be process according to the present invention. If this mode is active, then in step 602 the algorithms to enable end to end P25 Encryption and/or Voice is enabled.

In step 603 a check is made to see if the packet arriving is downlink. If this is the case, then in step 606 the P25 Phase II Voice Codewords are extracted from the P25 Phase II packet. In step 607 the P25 Phase II Voice codewords are embedded into a P25 Phase I signal. In step 608 the DUID is set in the P25 Phase I signal to indicate to receiving terminals that P25 Phase II is present. In step 609 the packet is transmitted on the downlink.

At step 603, if the received packet was not downlink then a further check is made at step 604 to detect uplink. If this is the case, then in step 610 a check is made to verify the packet contains P25 Phase II as indicated by the DUID setting. In step 611 the P25 Phase II voice codeword is extracted from the P25 Phase I uplink packet. This is copied without modification into the P25 Phase II packet ready for uplink transmission. In step 613 the uplink P25 Phase II packet is transmitted.

In step 605 a check is made to see if this mode has been deactivated. If it has not, then continual checks are made on incoming downlink and uplink packets in steps 603 and 604.

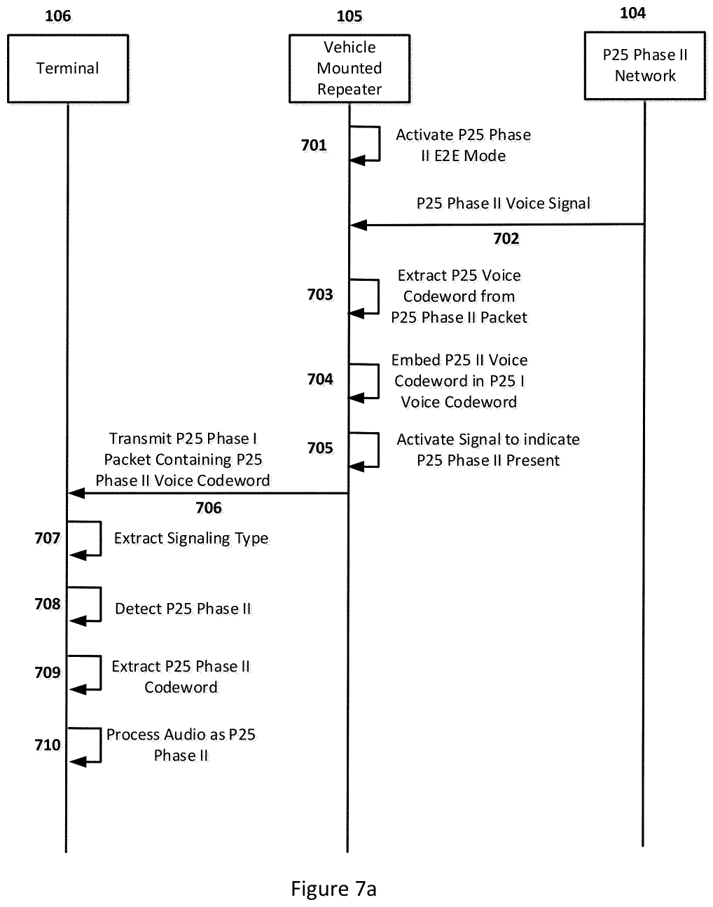

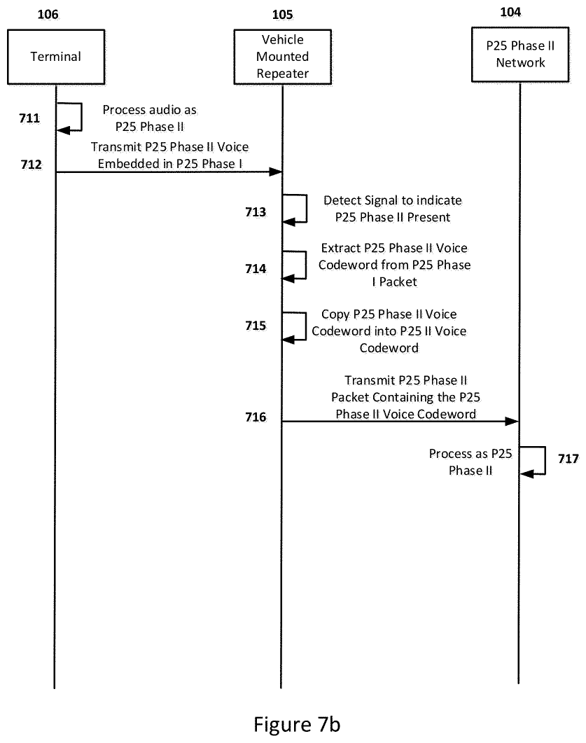

FIG. 7a shows a sequence diagram illustrating the downlink process. In step 701 the end-to-end mode is activated at the VMR 105. In step 702 a P25 Phase II signal is sent from the network 104 and received at the VMR 105. In step 703 the P25 Phase II Voice codeword is extracted from the P25 Phase II signal and in step 704 it is embedded in a P25 Phase I packet. In step 705 the DUID is set to indicate the presence of P25 Phase II voice codewords. In step 706 the P25 Phase I signal is sent on the downlink and received at the terminal 106. In step 707 the signalling type is extracted, meaning the DUID is read. In step 708 the presence of P25 Phase II is detected. In step 709 the P25 Phase II voice codewords are extracted from the P25 Phase I packet and in step 710 the P25 voice codewords are processed according to P25 Phase II operation using the AMBE Half Rate vocoder and P25 decryption protocols.

FIG. 7b shows a sequence diagram illustrating the uplink process. In step 711 the terminal 106 processes audio from the microphone as P25 Phase II. In step 712 the P25 Phase I packet is transmitted containing the P25 Phase II voice code words. It is received at the VMR 105. In step 713 a check is made to detect the DUID is set indicating P25 Phase II is present. In step 714 the P25 Phase II voice codeword is extracted from the P25 Phase I packet. In step 715 this P25 Phase II voice codeword is copied into a P25 Phase II packet in preparation for transmission on the uplink in step 716 to the network 104. In step 717 the network 104 processes the received packet as normal P25 Phase II signalling.

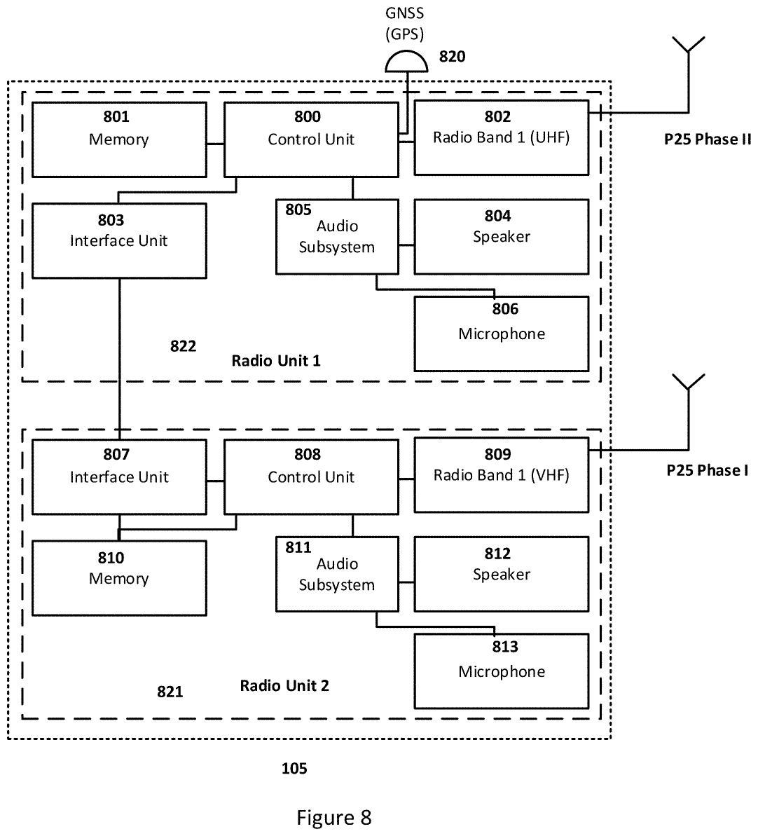

FIG. 8 shows a system description of a Vehicle Mounted Repeater 105. The VMR contains two radio units, 822 and 821 respectively. Radio unit 1 connected to the P25 Phase II network at 104. Radio unit 2 creates the local area of extended coverage. Both 822 and 821 contain the following. A control unit 800, 808 which is a processor and that implements control and communication functions. Either unit can carry out the processing of packets as required between receiving and transmitting the P25 signals. Each control unit connects to a GPS unit 820 for the purpose of identifying the device location. For convenience in this document the US technology is described which is GPS, however all forms of Global Navigation Satellite System (GNSS) are included. The computer programs that implement the algorithms on the platform are contained within local memory 801, 807 and executed on the VMR. An LMR radio 802, 809 are present and in this case, it is assumed 802 is a UHF frequency and 809 is a VHF frequency. Each of the 822 and 821 contain a microphone 806, 813 which are connected to audio subsystems 805, 811 though in the present invention they are not used. Each unit 822 and 821 also contains a digital interface 803,807 which is used to transfer digital data between the units for the purpose of repeating.

1. A Land Mobile Radio (LMR) repeater, comprising:
a first radio operating with a first LMR protocol(II), and
a second radio operating with a second LMR protocol(I);
wherein a signal containing packets of voice data encoded using the first protocol(II) received by the first radio, is processed by either radio, and
transmitted by the second radio as a signal encoded using the second protocol(I) containing the packets of voice data encoded using the first protocol(II); and
wherein a signal containing packets of voice data encoded using the second protocol (I) received by the second radio, is processed by either radio, and
transmitted by the first radio as a signal encoded using the first protocol (II) containing the packets of voice data encoded using the second protocol(I).

2. A radio user terminal having a transceiver, a processor and memory, the memory comprising instructions which cause the terminal to:
receive a signal in a protocol (I) containing packets of voice data encoded using a different protocol (II),
extract the packets of voice data encoded using the different protocol (II),
decode the packets of voice data using the different protocol (II), and
present the voice data to a user as audio; and
detect audio from the user,
encode the audio as packets using said different protocol (II),
embed the packets within a signal encoded using the protocol (I), and
transmit the signal using the protocol (I).

3. A method of operating a combined first technology/second technology radio, comprising:
receiving a voice call on a first LMR technology bearer and
identifying the portion of the received signal that contains voice packets of the first LMR technology and
extracting the voice packets of the first LMR technology and
embedding the voice packets of the signal of the first LMR technology into signaling of the second LMR technology and
transmitting the second LMR technology containing voice codewords of the first LMR technology.

4. The method according to claim 3, wherein the first LMR technology is P25 Phase II and the second LMR technology is P25 Phase I.

5. The method according to claim 3, wherein the voice call may be encrypted or unencrypted.

6. The method according to claim 3, wherein the zero padding is added in the second technology where the packet of the first LMR technology does not fill the packet of the second technology.
